(19) United States
(12) Patent Application Publication
(10) Pub. No.: US 2025/0196396 A1
(43) Pub. Date: Jun. 19, 2025

(54) Hopper with improved process fluid distribution system

(71) Applicant: MST Engineering dell'Ing. Francesco Marzaro, Caltana di S. Maria di Sala (VE) (IT)

(72) Inventors: Francesco Marzaro, Caltana di S. Maria di Sala (VE) (IT); Gianluca Bertoldo, Caltana di S. Maria di Sala (VE) (IT)

(21) Appl. No.: 18/847,236

(22) PCT Filed: Mar. 17, 2022
(86) PCT No.: PCT/IB2022/052431

§ 371 Date: Sep. 14, 2024

(30) Foreign Application Priority Data
Mar. 14, 2022 (IT) 102022000004925

(51) Int. Cl. B29B 13/06; F26B 17/12; F26B 17/14

(52) U.S. Cl. CPC B29B 13/065; F26B 17/122; F26B 17/1425; F26B 17/1458; F26B 2200/08

(57) ABSTRACT

A hopper for the heat treatment of a material contained therein includes a casing with an upper portion, into which the material to be treated is introduced, and a bottom part or lower portion, from which the material is discharged; a diffuser of a process fluid located inside the hopper; a system for introducing the process fluid inside the diffuser; a mixing chamber arranged to enclose at least the lower portion of the hopper externally; a system for introducing the process fluid inside the mixing chamber; and a system that fluidically connects the interior of the mixing chamber with the interior of the diffuser.

This patent relates to hoppers for the heat treatment of plastic granules and in particular concerns a new hopper with an improved process fluid distribution system.

### FIELD OF APPLICATION

The object of the present invention is a hopper with an improved system for distributing the process fluid and in particular the fluid used in hoppers for the treatment of granular materials, and a method for distributing the process fluid in the hopper.

In particular, the invention covered by this patent application can also be applied in the field of systems and devices for the dehumidification of plastic materials, and for their subsequent melting and molding in transformation machines.

In particular, the invention that is the object of this patent application relates to a system for the injection and distribution of fluid inside the hopper used by way of example, but not exclusively, for the heating and dehumidification of plastic materials or other granular materials such as food products, chemical pharmaceuticals, coal agglomerates, cement products, etc.

The proposed system therefore generally applies to those processes which generally use a fluid having dew point (DP) values and T° temperatures, by way of example, but not exclusively, DP<0° C. and temperatures up to T°=200° C., and in particular to heating and dehumidification systems for the plastic materials where this fluid is used to preheat and dehumidify the plastic materials inside a special hopper.

### STATE OF THE ART

As is known, plastic material, in the form of granules or flakes, is transformed into finished or semi-finished products by heating, melting, molding or extrusion.

As is also known, plastics, due to their hygroscopicity, contain water molecules; during melting processes, water molecules can compromise the polymeric structure of the plastic materials, causing surface or structural defects of a finished or semi-finished product, compromising the quality of the final product.

It follows that, in order to prevent the formation of bubbles and cavities in the plastic material and any alterations in its chemical structure, it is absolutely necessary to control the temperature and moisture content of the granules and thus the heating and dehumidification process, during the transformation of plastic materials.

In order to extract moisture from plastic material, various drying fluids are currently used to treat it.

In the dehumidification systems currently used, a certain amount of plastic material to be dehumidified is introduced into a hopper in which the material is subjected to the action of the drying fluid heated to a suitable temperature, called process fluid, which heats the material and removes the moisture.

It is known that the process fluid is conveyed by process fluid generators, typically air or air/nitrogen mixtures, known in jargon as the “dryer.”

Once the fluid is introduced into the container where the plastic material is stored, it passes through the plastic mass, heating it and removing the moisture.

Achieving the optimal degree of dehumidification for a given plastic material that will subsequently be subjected to melting is conditioned by numerous factors including the amount of time the material remains in the hopper, the flow rate of the process fluid, the treatment temperature, and the dew point of the process fluid itself.

To modify the residual moisture that the granular material retains at the end of the dehumidification treatment, the amount of time it remains in the hopper and the characteristics of the process fluid can be altered, as can the specific flow rate, temperature, and dew point.

Note that the dew point is that thermodynamic state in which, at a certain temperature and a certain pressure, a fluid-vapor mixture becomes saturated with water vapor.

By way of example, the description of a typical dehumidification process in PET transformation processes is provided below.

As is well known, a dehumidification fluid (air/nitrogen mixtures etc.) with a DP indicatively in the range of −80° C. to −30° C. and temperatures in the range of 80° C. and 200° C. are used for the transformation processes of plastic materials.

Table 1 below shows indicative values of the parameters of a known process by way of example.

TABLE 1

| | |
|---|---|
| Delivery pressure Pm (measured at the | 1.2 bar > Pm > 1.05 bar |
| dryer outlet) | |
| Return pressure Pr at the dryer inlet | 1.0 bar > Pr > 0.9 bar |
| Temperature Td of the columns in the | 40° C. < Td < 70° C. |
| dryer | |
| Temperature Tm of fluid delivered at | 80° C. < Tm < 200° C. |
| the hopper | |

Inside the dryer, there are special columns containing the adsorbent material capable of retaining the moisture present in the fluid.

Generally, the fluid leaving the dryer is conveyed along the delivery pipe to a heater and after having passed through the plastic material contained in special hoppers, it returns to the dryer along the return pipe, to transfer the moisture extracted from the material to the columns.

The process fluid is then sent back by the pump along the circuit to ensure that the material reaches the required temperature/humidity conditions. For the aforementioned reasons, the optimal condition is when the process fluid entering the hopper has a specific DP<−30° C. and, for PET, a temperature >160° C.

In the prior art, the distribution of the process air inside the dehumidification hopper is carried out using a diffuser located in the lower portion of the hopper. (FIG. 1).

The diffuser adopted in the prior art has two fundamental functions: to guarantee the homogeneous descent of the material and simultaneously guarantee the homogeneous distribution of the process air inside the hopper.

This diffuser, for example the one shown in FIG. 1, generally consists of an upper cone made of smooth sheet metal (11) with its vertex facing upwards, which has the purpose of creating counterpressure in the central part of the hopper, and a lower perforated inverted cone (12), that is, with its vertex facing downwards, from which the process fluid emerges into a zone not subject to the direct pressure of the material moving downwards.

The diffuser is typically supported by support brackets mounted between the lower cone and the conical wall of the lower part of the hopper. These brackets are in fact thermal bridges that contribute to limiting the effectiveness and homogeneity of the heat applied to the material and particularly the material present in the lower part of the hopper.

In the absence of the upper cone of the diffuser, the material descends predominantly towards the center with completely different vertical speeds compared to the speed of the material descending on the periphery.

This results in shorter transit times and thus insufficient heating and dehumidification of the treated material.

The perforated inverted cone is also used to introduce the process fluid at the lowest point, in a low pressure zone, to create the most effective countercurrent flow possible.

Crystallizers are also known in the prior art, an example of which is shown in FIG. 1, where the process fluid is introduced directly into the lower part of the hopper. This generally requires very high flow rates to overcome the gravity that pushes the material flowing downwards against the cone itself and to prevent the so-called “grating effect” of the material on the perforated walls of the inverted cone that produces wear as well as a large amount of dust.

Therefore, crystallizers use high process flow rates and a suction shaft placed inside the hopper to keep the material and the relative process fluid mixed, thus this system is significantly different than “static” hoppers.

We can therefore integrate the optimal configuration of the dehumidification hopper, as defined in the prior art, with a nozzle in which the position of the valve shutter determines the internal flow conditions.

In the prior art, static hoppers, that is, those without moving elements placed inside them, have achieved a rather standardized configuration over time that provides for the diffuser to be fed from the top of the hopper, through a vertical pipe located inside the hopper and generally connected to an external heating chamber.

In certain configurations, and in particular in small hoppers, the process fluid inlet can be placed at the bottom, at the height of the cone, with some advantages in terms of thermal efficiency.

However, the drawback of that configuration relates to the lack of uniformity generated when the material descends and in the distribution of the process fluid, with the potential formation of stagnation points and degradation of the material.

In large static hoppers, where this drawback is even more evident, this solution is not used to date. Therefore, if it can be said that the prior art comprises techniques able to achieve acceptable levels of homogeneity in the descent of the material and in the distribution of the process fluid, the problems related to the optimal thermal exchange and consequent distribution of the heat in the material descending through the hopper still remain.

In fact, the material descending at the periphery of the hopper, in contact with its metal surfaces, even when the latter are insulated, are cooler zones since they are the outer walls of the hopper.

It follows that, in particular in the lower part of the hopper, normally conical with the vertex facing downwards, there is a large temperature gradient between the material near the diffuser cone and that near the conical wall of the lower part of the hopper. In fact, this material arrives at that point already at lower temperatures than the material arriving from the center and the temperature gap is unable to be recovered, indeed it only increases in the last part of the descent inside the lower conical part of the hopper.

Since it is necessary to guarantee the material leaving the hopper a minimum temperature, as well as an optimal moisture content, it is necessary to increase the transit time in the hopper in order to allow the coldest portion of the material to reach this minimum temperature.

In this case, in the presence of delicate or low quality polymers such as recycled materials, it is easy to trigger polymer degradation processes, which lead to quality problems in the finished product.

Alternatively, it is possible to adjust the airflow rate by increasing it appropriately in order to provide the necessary energy in a limited time.

However, in this case, the efficiency of the system is compromised, since the energy consumption increases both to heat the process fluid in the heater and to cool it in the heat exchangers installed before the dryer.

In this second case, in which it is necessary to operate with limited transit times in the hopper, a further energy problem arises in the solutions adopted in the prior art.

In fact, reduced transit times in the hopper lead to a reduction of material levels. Thus, a remarkable portion of the central hot fluid inlet pipe is exposed to the cooling action of the fluid as it leaves the material that can be seen as a sort of thermal bypass.

As a result, the temperature of the incoming fluid decreases with respect to the required value while the temperature of the outgoing fluid increases even to significant values.

Typically, for example for PET, there is an increase of the return temperatures from its standard 80° C. to 120-130° C.

Thus, the increase in energy consumption is significant with the resulting economic consequences.

Another phenomenon emerging from hoppers made according to the prior art, relates to the difficulty controlling the temperature of the process fluid leaving the heating chamber.

In fact, to reduce heat loss, the heater is located next to the hopper near the inlet point, with the temperature control probes generally installed at point T1, with reference to FIG. 1.

This condition involves a certain instability in the reading of temperatures, associated with stratification phenomena that are difficult to predict, such as to make it difficult to thermoregulate the process.

In order to overcome this phenomenon, it is generally necessary to install turbulators and thermal destratifiers that exacerbate both the costs and the pressure drops and which also result in a significant increase in the size of the equipment.

As noted, the use of recycled resins comes with the need to prevent the thermal degradation of the resins during the dehumidification process.

This can be achieved by limiting the working temperature in the hopper, which may result in a dehumidified polymer that is not hot enough to be transformed.

This problem can be solved by equipping the system with a second small hopper, known as a booster in jargon, located downstream of the main hopper and where the material encounters a very hot air flow for a short time before being forwarded to the processing machine.

Thus, the process tends to be split into a dehumidification and preheating phase at 80-90% of the required temperature and a quick final heating phase to the required temperature.

This solution typically involves a transport system from the primary hopper to the booster, with a high temperature transport pump, insulated lines, high temperature closed circuit ventilation pump, electrical power panel, and various ancillary systems.

Therefore, this embodiment results in a significant increase in costs and energy consumption, due to the inevitable dispersions inherent to the system.

### OBJECT OF THE INVENTION

The object of the invention that is the subject of this patent application is therefore to optimize the working conditions in the hopper, reduce heat losses, and offer the possibility of working with polymers sensitive to thermal degradation, with a simultaneous significant reduction in energy consumption.

### Reduction of Heat Loss in the Upper Portion of the Hopper

To reduce heat loss in the working phases with reduced material levels, the process fluid inlet pipe located above the diffuser inside the hopper was eliminated.

### Reduction of Heat Loss in the Lower Portion of the Hopper

To reduce the cooling of the material in the lower conical portion of the hopper, the lower surface of the hopper must be heated.

### Reduction of Dispersion in the Diffuser Cone

To reduce heat loss at the diffuser cone, the thermal bridges represented by the diffuser cone support structures resting on the lower part of the hopper were reduced.

### Increased Heat Recovery by Contact

To increase the heat exchange in the lower conical part of the hopper, the hot surfaces of the diffuser cone were increased.

### Increased Heat Recovery by Diffusion of the Process Fluid

To improve the distribution of the process fluid near the diffuser cone, the active surface of the fluid inlet was increased, without generating preferential pathways, however.

### Reduction of Temperature Stratifications in the Heater

The stratification phenomena in electric heaters used in the prior art are increased by natural convection phenomena that occur when the air introduced into the heater from the lower portion heats up when going up along the heater itself.

In particular, at low flow rates, the fluid tends to accelerate vertically naturally by convection, maintaining a state of relative stability.

If the inlet direction is reversed by entering from above, in particular at low flow rates, the inlet flow opposes convective movements and generates turbulence that facilitates mixing.

This results in the greater homogeneity of the outbound temperature.

### Reduction of Temperature Stratifications in the Diffuser Cone

An initial improvement regarding temperature uniformity of the fluid entering the diffuser cone was achieved by eliminating the vertical inlet duct.

In fact, as can also be seen with direct measurements, the temperature in the peripheral part of the inlet pipe of the embodiments of the prior art can be up to 10-20° C. lower than that measured at the center of the pipe itself.

It follows that, particularly at low flow rates and under stable flow conditions, even if not laminar, the base of the diffuser cone has lower temperatures than those measured at the vertex.

This does not help to ensure temperature uniformity of the material.

In order to reduce these stratification phenomena inside the diffuser cone, a mixing chamber was added where the process fluid flow coming from the heater can mix well before being sent inside the diffuser cone, located inside the hopper.

### DESCRIPTION OF THE INVENTION

Referring to the various points addressed above, a new hopper configuration was developed, with an improved process fluid distribution system.

The new hopper comprises a casing with a lower part, or bottom part, generally conical or with a tapered shape with its vertex facing downwards.

Around the lower part of the hopper, an annular mixing chamber is installed, with insulated outer walls, inside which the process fluid is blown. If provided, said process fluid comes from a heater.

Inside the hopper, near said lower part, a diffuser is installed which consists of a hollow body on the wall of which there are holes that connect the interior of the diffuser with the interior of the hopper.

Said diffuser has, for example, the shape of the diffusers of the prior art, that is, comprising an upper cone and a perforated lower cone.

Diffuser supports are also provided, which are installed between the diffuser and the lower part of the hopper.

Said mixing chamber has the dual function of mixing the incoming flow of process fluid to have stable temperatures before its introduction into the diffuser cone of the hopper, and heating the entire lower portion of the hopper, which currently represents a cold zone of the system.

Said lower portion of the hopper as a heat dispersing element thus becomes an active component of the heating system because when heated by the hot process fluid introduced into the mixing chamber, it transmits heat to the material contained in the hopper and in particular to the material present in the lower portion of the hopper.

Even the diffuser supports, which in the prior art are detrimental thermal bridges with the external environment, become active components of the heating system.

In fact, they comprise ducts that connect the interior of said mixing chamber with the interior of said diffuser. The hot process fluid flows from the chamber and, through said ducts of the supports, reaches the interior of the diffuser.

The diffuser cone supports can also be used to distribute a part of the process fluid directly to the interior of the hopper, through holes made in the ducts, thus increasing the diffusion of the fluid into the material descending in the hopper.

The preferred embodiment, which feeds the diffuser cone from the annular chamber, also allows the supply pipe to be eliminated which, in the prior art, is located inside the hopper, above the diffuser.

It follows that the dispersion generated at the top of the hopper in situations of partial loads, that is, with a hopper fill level below 100%, is in fact eliminated.

The process fluid inlet in the lower portion of the hopper makes it easy to position the air inlet in the upper portion of the electric heater, if present, with the following advantages.

In this case, therefore, the stratification phenomena in the heater and therefore the temperature inconsistencies often found in the systems of the prior art are reduced.

The inlet of the process fluid into the lower portion of the hopper provides an additional advantage, which is that it can be used in systems with differentiated process temperatures, for example as in the cases described above, with reference to booster systems.

It is in fact possible, in a fairly simple way, to take a part of the process fluid flow from the annular chamber or downstream of the heater and send it to a chamber or auxiliary compartment possibly located below the hopper, at or near the point of discharge of the material from the hopper.

The fluid passes through an auxiliary heater that increases the temperature of the fluid.

The hot flow from this chamber or auxiliary compartment may not be sent to the dryer, with the consequent increase of the cooling effect on the material, but may be introduced into the lower portion of the hopper, contributing to further heat and homogenize the temperature of the material present in the hopper.

In fact, in its ascent along the lower portion, the fluid coming from the auxiliary compartment tends to go to the periphery of the hopper, since the air leaving the diffuser cone generates positive pressure in the central area.

Therefore, it is possible to obtain a secondary heating effect on the material located in the periphery of the hopper which, in hoppers made according to the prior art, tends to be slightly cooler than that located in the center.

In this case, it is also possible to greatly simplify the architecture of dual temperature systems with clear economic and management advantages.

Thanks to the system of the invention for the distribution of the process fluid inside a hopper for the treatment of granular materials, it is therefore possible to reduce, if not eliminate, many of the drawbacks inherent to the systems made according to the prior art, improving the quality and reliability of the process.

### BRIEF DESCRIPTION OF THE DRAWINGS

The technical characteristics of the invention, according to the aforementioned objects, can be found in the content of the claims and the advantages thereof will be better clarified in the detailed description that follows, made with reference to the attached drawings that represent one or more embodiments by way of non-limiting examples:

FIG. 1 shows a diagram of a generic dehumidification system according to the prior art. FIG. 1a shows a crystallizer made according to the prior art;

FIG. 2 shows a diagram of a first embodiment of the system of the invention;

FIG. 3 shows a partial diagram of the hopper (15) and of the process fluid distribution system in a functional variant to the first embodiment of the invention wherein a diffusion surface (26) at the base of the hopper (15) is provided;

FIG. 4 shows a partial diagram of a functional variant to the first embodiment of the invention wherein an external auxiliary compartment (27) at the base of the hopper, with relative heater (29) is provided;

FIG. 5 shows a partial diagram of the system with a functional variant to the first embodiment of the invention, wherein the auxiliary compartment (27) with its heater (29) is added to the configuration of FIG. 3;

FIG. 6 shows a partial diagram of the system with a functional variant to the first embodiment of the invention, wherein a heater (9a) is partially integrated in the mixing chamber (24);

FIG. 7 shows a partial diagram of the system with a functional variant to the first embodiment of the invention, where there is an external duct (14a) for the fluidic connection of the mixing chamber (24) and the interior of the diffuser cone (10).

FIG. 8 shows a partial diagram of the system with a functional variant to the first embodiment of the invention, where there is an external duct (14b) and an internal duct (141b) for the fluidic connection of the mixing chamber (24) and the interior of the diffuser cone (10).

FIG. 9 shows a partial diagram of the system with a functional variant to the first embodiment of the invention, where the diffuser cone (10) is fed through the supports (14) that connect it to the mixing chamber (24), and through a standard vertical internal duct (14c) connected to the heater (9).

FIG. 10 shows a partial diagram of the system with a functional variant to the first embodiment of the invention, with two heaters (9, 9a), where the first heater (9) heats the process fluid to the temperature T1 for its introduction into the vertical duct (14c) inside the hopper (15), while the second heater (9a), in series with the first, heats the process fluid to the temperature T2, before its introduction into the mixing chamber (24).

FIG. 11 shows a partial diagram of the system with a functional variant to the first embodiment of the invention, where the auxiliary compartment 27, with its heater (29), which heats the process fluid to the temperature T3 is added to the configuration of FIG. 10.

### DETAILED DESCRIPTION

In the description and in the claims reference is made to a process flow for carrying out the dehumidification of plastic or granular material; it is understood that the expression “process fluid” is not limited to the use of air but also includes the use of other treatment fluids suitable for the purpose and that this process fluid could also be used for purposes other than the dehumidification of the plastic material such as the treatment of other granular materials like cereals, minerals, vegetables, and the like.

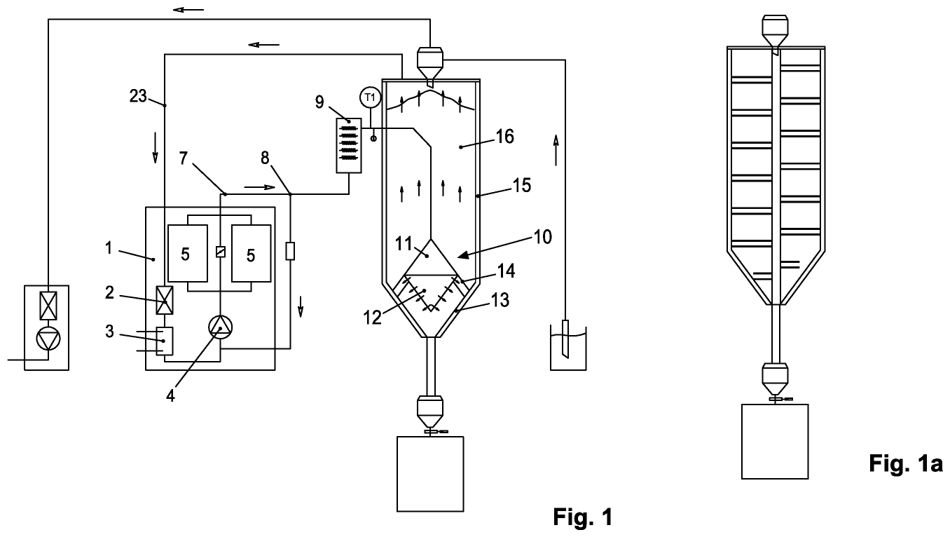

In accordance with a general embodiment of the invention, the dehumidification system shown in FIG. 1 comprises:
at least one dry fluid generator (1), said generator called dryer, inside which there are special columns (5) containing adsorbent material capable of retaining the moisture present in the process fluid;
preferably but not necessarily at least one filter (2);
preferably but not necessarily at least one cooler (3);
at least one heater (9);
preferably but not necessarily at least one replenishment port;
preferably but not necessarily at least one sampling port (8).

The heater (9) may be based on different technologies (electricity, gas, etc.) and may also be placed in different positions of the dehumidification system, depending on specific needs.

The standard dehumidification system typically used in the usual practice also includes:
at least one hopper (15) in which the plastic material (16) is placed;
at least one heater (9);
at least one delivery pipe (7) of the process fluid from the generator (1) to the heater (9);
at least one return pipe (23) of the process fluid exiting the hopper (15);
at least one pump or blower (4).

Generally, the process fluid leaving the dryer (1) flows through the delivery pipe (7) to a heater (9).

From the heater (9) the fluid is sent inside the hopper (15) through a generic diffuser (10) usually made of a smooth upper cone (11) and a perforated lower cone (12) so as to pass through the plastic material (16) contained therein.

When the process fluid loaded with the humidity absorbed from the plastic material (13) reaches the top of the hopper (12), it passes through the return pipe (22) with a specific flow rate (Q) and is then sent back to the dryer (1).

The fluid is once again pumped by the pump (4) into the columns (5), along the delivery circuit (7), to the heater (9), hopper (15) and return circuit (23), to ensure that the material (16) reaches the temperature/humidity conditions required by the transformation machine (22).

The hopper (15) comprises a bottom or lower portion (13) for example substantially conical or with a tapered shape with its vertex facing downwards.

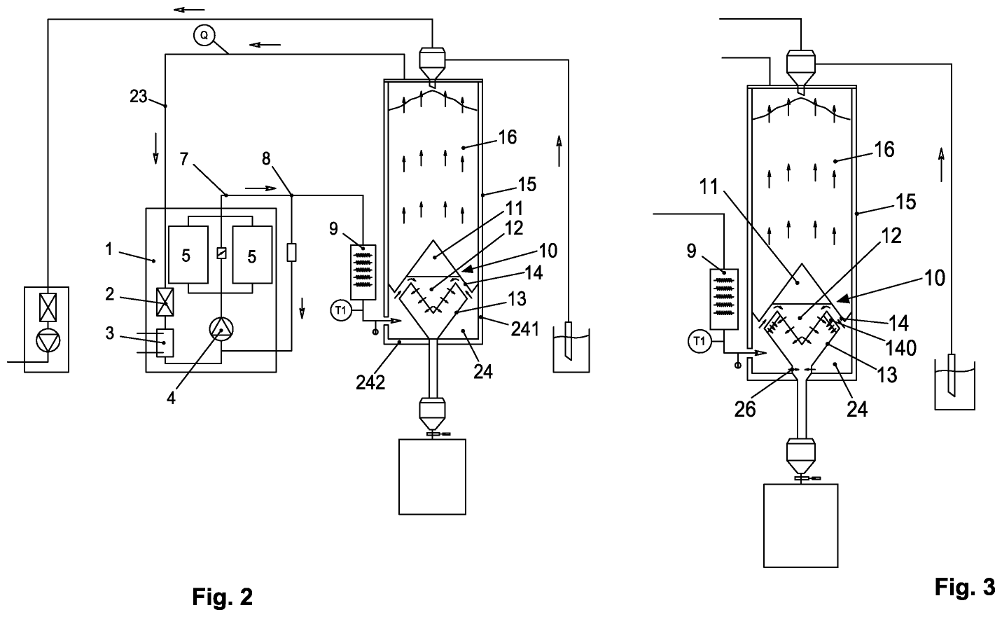

As shown in FIG. 2, according to a primary embodiment of the invention, the hopper (15) comprises at least one mixing compartment or chamber (24) located below and around the lower portion (13) of the hopper (15). Said chamber (24) is, for example, characterized by insulated side walls, for example a cylindrical wall (241), and an insulated base, for example circular (242), which enclose said lower portion (13) of the hopper (15). However, this chamber may be created with other configurations.

Said lower portion (13) of the hopper (15), in contrast, may be suitably made with an uninsulated wall, to improve the heat exchange between the mixing chamber (24) and the interior of the hopper (15).

A preferable embodiment of the present invention has said lower portion (13) with closed walls, that is, without openings that connect said mixing chamber (24) directly with the interior of the hopper (15).

Said at least one diffuser (10) may be made of a smooth upper cone (11) and a perforated lower cone (12) as in the prior art, without excluding any embodiment not shown in the attached figures.

Said at least one mixing chamber (24) may or may not be fluidically connected with said diffuser (10), and where the means of connection may be implemented in different ways, only some of which are indicatively referred to in the claims.

The object of the present patent application is therefore to use a fluid to heat at least the lower portion (13) of the hopper (15), in order to reduce heat dissipation and optimize the process.

In particular but not exclusively, the fluid used for heating part of the hopper may be the process fluid exiting the heater (9), without excluding the possibility of using the return process fluid (23) or other available fluid.

In a first embodiment (FIG. 2), the system provides for said at least one hopper (15), said at least one mixing chamber (24) containing said lower portion (13) of the hopper (15), at least one diffuser (10) possibly connected with said mixing chamber (24) by means of the support brackets (14) of the diffuser (10) itself.

Said brackets (14) are for example tubular or comprise ducts that connect the interior of said mixing chamber (24) with the interior of said diffuser (10).

In a preferred embodiment (FIG. 3), there may be at least one diffusion surface (140) on at least one of the support brackets (14) of the internal diffuser. For example, the walls of the brackets (14) may be perforated.

In a further preferred embodiment (FIG. 3), a diffusion surface (26) may be included near the base of the hopper cone (13), in order to improve the manner in which the material encounters the process fluid. For example, the lower end of the lower portion (13) may have a perforated cylindrical neck for the passage of the process fluid coming from the mixing chamber (24).

In a further preferred embodiment (FIG. 5) there may be at least one outer auxiliary compartment (27), located below the lower portion (13) of the hopper (15) intended to receive the material leaving the hopper (15). Inside said auxiliary compartment (27) the material (16) encounters a flow at temperature (T2) obtained by diverting a part of the process flow (Q2) from inside the mixing chamber (24) at the temperature (T1) through at least one extraction point (28), with the subsequent heating to the temperature (T2) through at least one auxiliary heater (29).

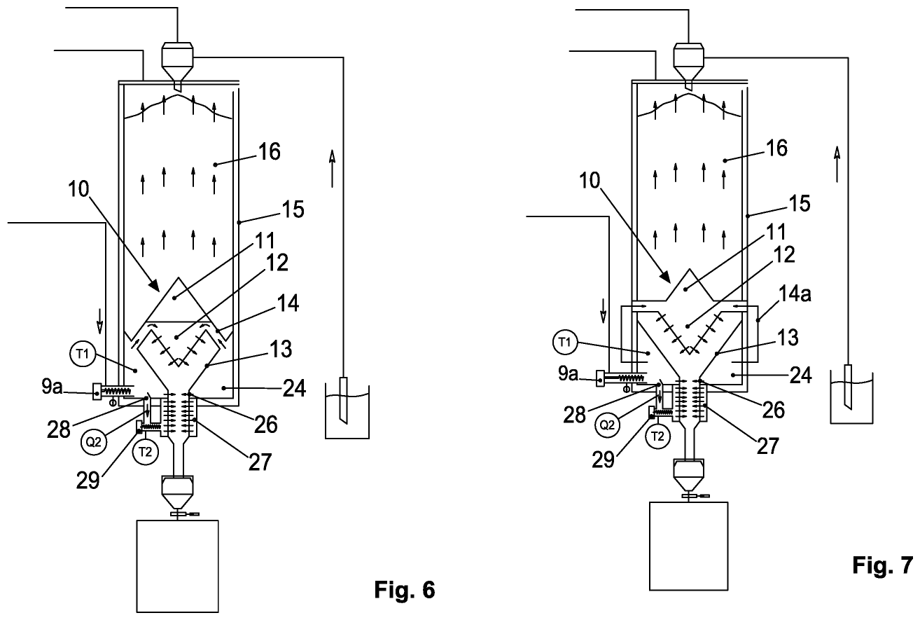

In a further preferred embodiment (FIG. 6), said heater (9a) may be at least partially integrated inside the mixing chamber (24).

FIG. 7 shows an alternative embodiment in which at least one diffuser (10) is connected to said mixing chamber (24) through at least one connection element or duct (14a) outside the hopper (15).

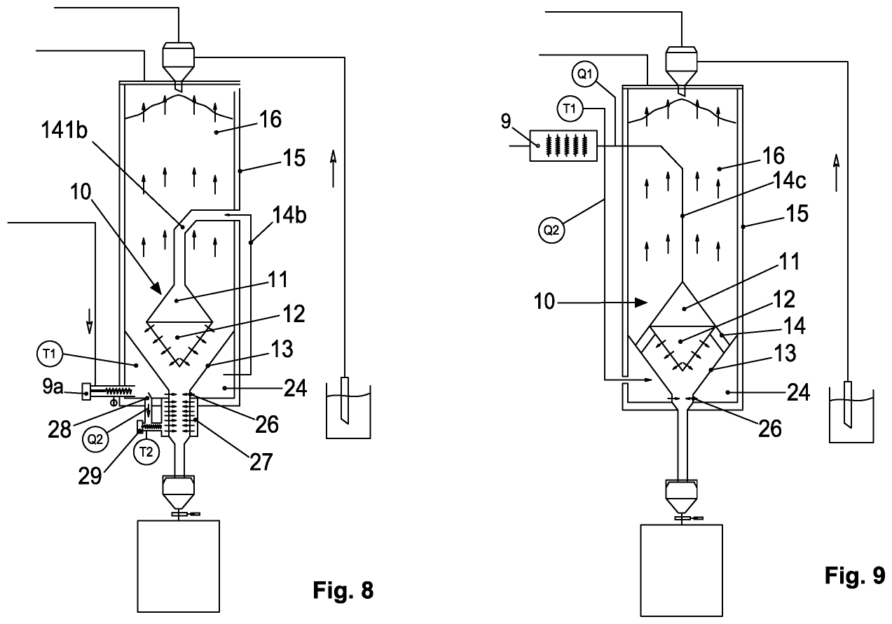

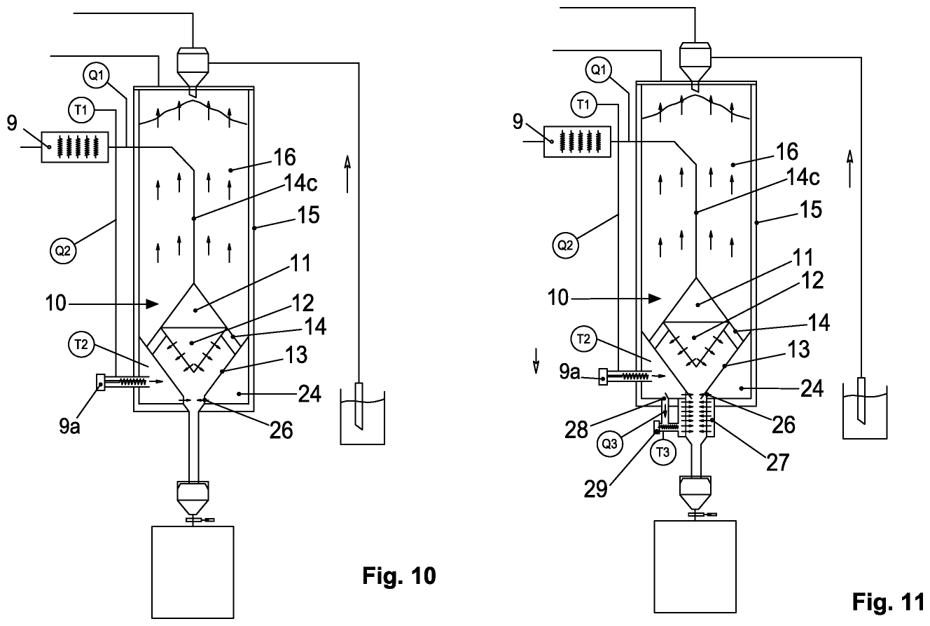

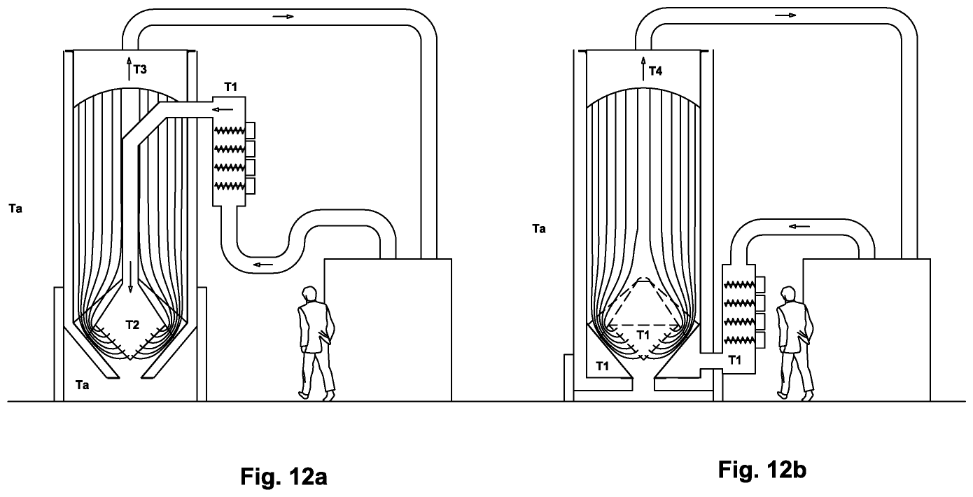

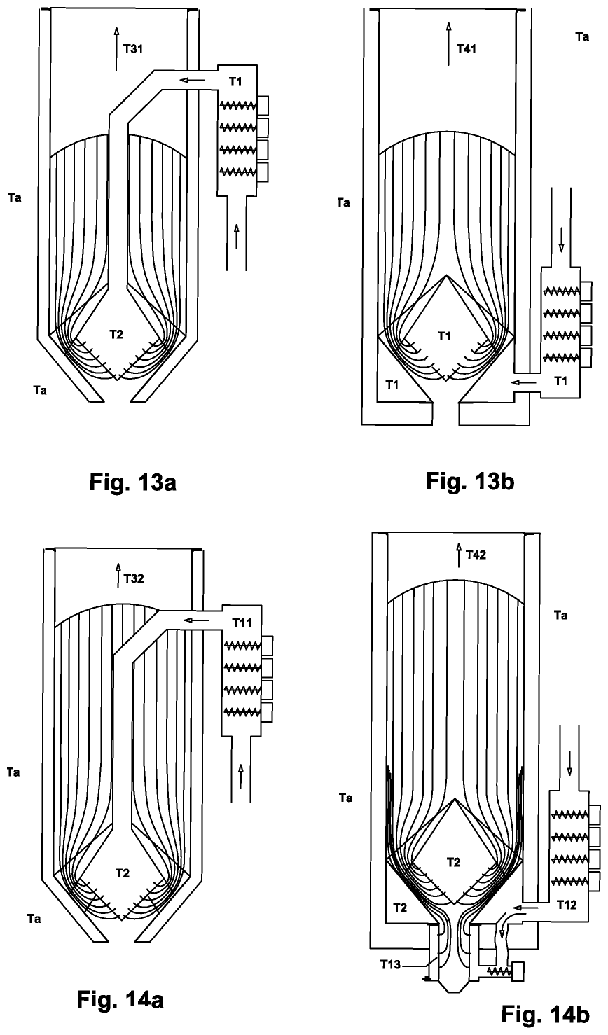

FIG. 8 shows an alternative embodiment in which at least one diffuser (10) is connected to said mixing chamber (24) through at least one connection element or duct (14b) outside the hopper (15) and connected to a duct (141b) inside the hopper (15). Said duct (141b) inside the hopper (15) is connected to the diffuser (10) and then carries the process fluid inside the diffuser (10) from above.

In FIGS. 12a and 12b two systems are compared by way of an example, where FIG. 12a shows the system according to the prior art, while FIG. 12b shows the system according to the present invention. In these Figures, the flows circulating inside the hoppers are shown schematically, where the material level is high.

With the same ambient conditions (Ta=35° C.) and heater outlet fluid conditions (T1=180° C.), in the embodiment of FIG. 12a related to the prior art, it is shown how the fluid has a temperature T2 of 170° C. inside the diffuser, and an outlet temperature T3 of 80° C.

In contrast, in the embodiment of the invention in FIG. 12b, the temperature inside the mixing chamber and in the diffuser is substantially equal to the inlet temperature T1=180° C., while the outlet temperature T4 is equal to 70° C.

Similarly, see FIGS. 13a and 13b, where the material level is lower, and where the outlet temperature T31 in the embodiment according to the prior art (FIG. 13a) is 120° C., while the outlet temperature T41 in the embodiment according to the present invention (FIG. 13b) is 100° C.

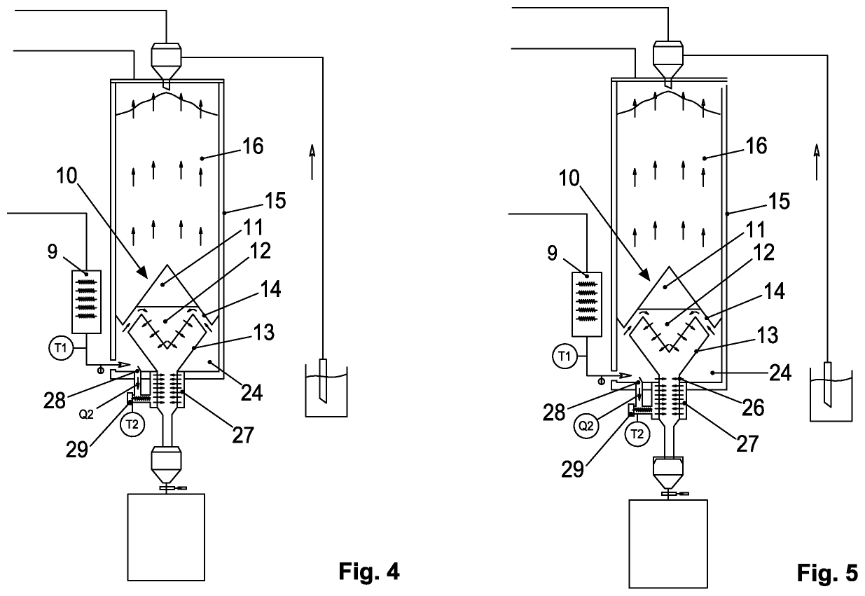

FIGS. 14a and 14b compare the embodiment according to the prior art (FIG. 14a) with the embodiment of the invention of FIG. 4 (FIG. 14b), where T11=175° C., T32=90° C., T12=170° C., T2=170° C., T13=190° C., T42=80° C.

Therefore, with reference to the preceding descriptions and the attached drawings the following claims are made.

The invention claimed is:

1. A hopper (15) for heat treatment of a material (16) contained therein, the hopper comprising:
a casing with an upper portion, into which the material to be treated is placed, and a bottom part or lower portion (13), from which the material is removed;
a diffuser (10) of a process fluid, said diffuser (10) being positioned inside said hopper;
means for introducing said process fluid into said diffuser (10);
a mixing chamber (24) configured to enclose at least said lower portion (13) of said hopper externally;
means for introducing said process fluid into said mixing chamber (24); and
means for a fluidic connection of an interior of said mixing chamber (24) with an interior of said diffuser (10).

2. The hopper (15) according to claim 1, wherein said lower portion (13) has no openings that connect said mixing chamber (24) directly with an interior of the hopper (15).

3. The hopper (15) according to claim 1, wherein at least said lower portion (13) of the hopper (15) is in whole or in part made of a thermoconductive material, to allow heat exchange between said mixing chamber (24) and an interior of said hopper (15).

4. The hopper (15) according to claim 1, wherein said means for a fluidic connection of the interior of said mixing chamber (24) with the interior of said diffuser (10) comprise one or more ducts (14, 14a, 14b, 141b) connected with the interior of said mixing chamber (24) and with the interior of said diffuser (10).

5. The hopper (15) according to claim 4, wherein said diffuser (10) comprises support brackets (14) mounted inside the hopper (15), between said diffuser (10) and said lower portion (13) of the hopper (15), and wherein said brackets (14) are tubular or comprise ducts connected with the interior of said mixing chamber (24) and with the interior of said diffuser (10).

6. The hopper according to claim 5, wherein said support brackets (14) comprise at least one diffusion surface (14a), for diffusing the process fluid inside said hopper (15).

7. The hopper (15) according to claim 4, further comprising at least one duct (14a, 14b) placed externally with respect to walls of the hopper (15) and communicating with the interior of said mixing chamber (24) and with the interior of said diffuser (10).

8. The hopper (15) according to claim 7, further comprising a duct (141b) placed vertically inside the hopper (15) above said diffuser (10) and communicating with the interior of said mixing chamber (24) and with the interior of said diffuser (10).

9. The hopper (15) according to claim 1, further comprising a diffusion surface (26), adjacent to a discharge opening of said lower portion (13) of the hopper (15), to diffuse the process fluid from the mixing chamber (24) inside said lower portion (13) of said hopper (15).

10. The hopper (15) according to claim 1, further comprising a heater (9a) of the process fluid entering said mixing chamber (24), wherein said heater (9a) is at least partially integrated inside the mixing chamber (24).

11. The hopper (15) according to claim 1, further comprising:
an external auxiliary compartment (27), located below the lower portion (13) of the hopper (15) and configured to receive the material leaving the hopper (15);
means for introducing into said external auxiliary compartment (27) an amount of flow rate of said process fluid (Q2) taken from said mixing chamber (24) at a temperature (T1); and
an auxiliary heater (29) that heats said process fluid to a second temperature (T2) before said process fluid is introduced into said external auxiliary compartment (27).

12. The hopper (15) according to claim 1, further comprising:
a first heater (9) that heats the process fluid to a first temperature (T1);
an input line (14c) for injecting said process fluid at the first temperature (T1) inside said diffuser (10);
a second heater (9a) that heats to a second temperature T21 an amount of flow rate of the process fluid (Q2) taken from said input line (14c); and
means for introducing the process fluid at said amount of flow rate (Q2) into said mixing chamber (24).

13. A plant for heat treatment of a material (16) contained in a hopper (15) as per claim 1, the plant comprising:
a generator (1) of the process fluid that is dry;
a heater (9) configured to heat said process fluid prior to its introduction into said hopper (15);
a delivery pipe (7) of the process fluid extending from the generator (1) to the heater (9);
a return line (23) of the process fluid exiting the hopper (15); and
means for introducing said process fluid from said heater (9) and/or from said return line (23) into said mixing chamber (24).
